(19) United States
(12) Patent Application Publication
(10) Pub. No.: US 2023/0412418 A1
(43) Pub. Date: Dec. 21, 2023

(54) APPLIANCE AND FOOD MANAGEMENT SYSTEM

(71) Applicant: Haier US Appliance Solutions, Inc., Wilmington, DE (US)

(72) Inventors: Haitian Hu, Louisville, KY (US); Hairong Li, Louisville, KY (US)

(21) Appl. No.: 17/841,805

(22) Filed: Jun. 16, 2022

(51) Int. Cl. H04L 12/28; G06F 16/538; G06F 16/58

(52) U.S. Cl. CPC H04L 12/2827; G06F 16/538; G06F 16/5866; H04L 2012/285

(57) ABSTRACT

A system and method for data transmission and appliance communication is provided. The system is configured to obtain a food identifier input and a preparation instruction input, generate a database correlating the food identifier input to the preparation instruction input, capture an image of food to be prepared, transmit the image of food to be prepared to a computing system, compare, at the computing system, the captured image to the database, and determine a preparation instruction corresponding to the captured image.

### FIELD OF THE INVENTION

The present subject matter relates generally to interconnected appliances, and more particularly to systems and methods for data transmission to an appliance and methods for operating an appliance.

### BACKGROUND OF THE INVENTION

Pre-made or prepared foods, such as may be cooked or warmed up in a microwave, oven, air fryer, or other cooking appliance, provide users convenience, and save time and energy from the user. Prepared foods can be heated and eaten at any time in a relatively short period of time to warm up or cook.

Prepared foods generally include preparation instructions for cooking of heating up the meal at certain cooking appliances. However, different cooking appliances may have different power settings, such as different output voltage or different heat output, or different methods of heating the food, such as via microwave or convection, etc. Furthermore, prepared foods often have general instructions, but different users may have particular user preferences for heating certain meals or using certain cooking appliances.

Still further, a user must generally retain the packaging at which preparation instructions are generally printed for the prepared foods. However, the packaging for prepared foods may be bulky, resulting in consuming space at a refrigeration or freezer appliance or storage pantry. A user may desire to remove the packaging to save space. However, the preparation instructions must be retained or else a user may be inhibited from desirably preparing the prepared foods.

Accordingly, systems and methods allowing for retention and customization of cooking and preparation instructions is desired.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a method for data transmission and appliance communication. The method includes obtaining a food identifier input and a preparation instruction input; generating a database correlating the food identifier input to the preparation instruction input; capturing an image of food to be prepared; transmitting the image of food to be prepared to a computing system; comparing, at the computing system, the captured image to the database; and determining a preparation instruction corresponding to the captured image.

Another aspect of the present disclosure is directed to an appliance data transmission system. The system includes an imaging device, a cloud-computing system, and a cooking appliance. The system is configured to obtain and transmit, via the imaging device, a food identifier input and a preparation instruction input to the computing system; generate a database comprising the food identifier input correlated to the preparation instruction input; capture and transmit, via the imaging device, an image of food to be prepared; compare, at the computing system, the captured image to the database; and determine a preparation instruction corresponding to the captured image.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic diagram depicting an appliance data transmission in accordance with aspects of the present disclosure.

FIG. 2 provides a flowchart outlining steps of a method for data transmission and appliance communication in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

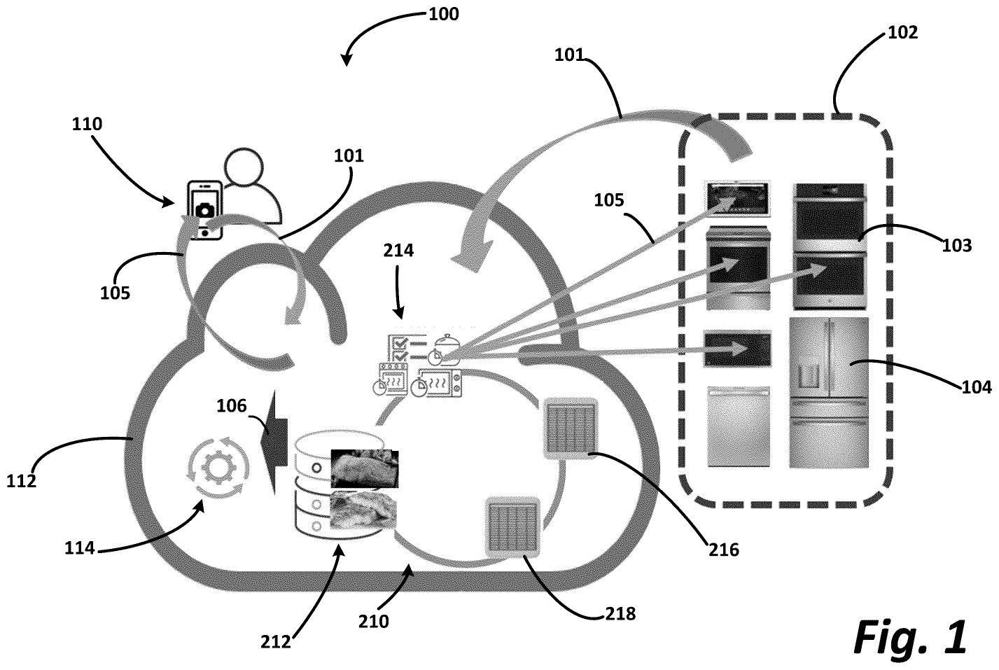

Referring now to FIG. 1, embodiments of an appliance data transmission system 100 will be described in accordance with exemplary embodiments of the present subject matter. In certain embodiments provided herein, a computing system 112 is communicatively coupled to one or more appliances 102 or remote user interface device 110 to receive inputs, depicted schematically via arrows 101, corresponding to a food preparation instruction 214 and a food identifier 212, such as an un-prepared food image, identification code, or other identifying data (e.g., a barcode, a QR code, etc.). Particular embodiments of the appliance 102 are configured to obtain an un-prepared food image, i.e., frozen food, raw food, cold food, etc. The food preparation instruction 214 includes cook power, cook duration, changes in heat output, or other cooking parameters associated with foodstuffs. Inputs 101 received at the computing system 112 form a database 210, such as a food personality system, correlating the un-prepared food image 212 to the food preparation instruction 214.

In various embodiments, inputs 101 may include user modifications 216 to the food preparation instruction 214. Database 210 further includes the user modifications 216, such as user changes to one or more parameters associated with the food preparation instruction 214. As further described herein, user modifications 216 may include manual inputs or changes to one or more parameters associated with the food preparation instruction 214. For instance, the food preparation instruction 214 may include a first cook power or a first cook duration. The user modification 216 may provide an override to the food preparation instruction 214 to utilize a second cook power or a second cook duration different from the first cook power and first cook duration, respectively.

In still various embodiments, inputs 101 include learned modifications 218 to the food preparation instruction 214. Database 210 further includes the learned modifications 218, such as changes to one or more parameters associated with the food preparation instruction 214 resulting from behaviors, commands, changes, or other operations a user may perform during food preparation (i.e., cooking, heating, de-frosting, etc.). As further described herein, the user may provide the input 101 including the food preparation instruction 214 corresponding to the un-prepared food (e.g., un-prepared food image 212). During food preparation, user commands to stop or extend the cook duration, or user commands to change the cook power, or other appropriate user commands associated with preparing the food, are stored and transmitted as learned modifications 218 to the food preparation instruction 214.

The food preparation instruction 214 may form signal or dataset corresponding to an initial or base instruction for preparing food. For instance, the food preparation instruction 214 may correspond to instructions provided from packaging of a frozen foodstuff, a recipe, or other input as may be obtained from print, a barcode, a QR code, from a manufacturer, from a webpage, etc. In certain instances, the food preparation instruction 214 may include ranges, such as, but not limited to, cook duration ranges, cook power ranges, cooking appliance types (e.g., microwave, oven, stovetop, etc.), or other food parameter variables.

The user modification 216 may particularly correspond to a user choice of particular or discrete cook durations, cook powers, or cooking appliances, such as may be based on the initial instruction provided from the food preparation instruction 214. For instance, the food preparation instruction 214 may include a cook duration range of four (4) minutes to six (6) minutes. The user modification 216 may particularly correspond to the user choice of five (5) minutes and thirty (30) seconds. In another instance, the food preparation instruction 214 may include a cook power range of 365 degrees Fahrenheit to 385 degrees Fahrenheit for an over appliance. The user modification 216 may particularly correspond to the user choice of 370 degrees Fahrenheit. In still another instance, the food preparation instruction 214 may include a cook power range of 70% to 85% for a microwave appliance. The user modification 216 may particularly correspond to the user choice of the cook power of 85%. Accordingly, the computing system 112 may receive the food preparation instruction 214 as allowable ranges or options and further receive the user modification 216 as discrete selections from the allowable ranges or options. However, it should be appreciated that the user modification 216 may extend above or below the ranges or options provided by the food preparation instruction 214. Still further, it should be appreciated that the user modification 216 may include variables not otherwise provided in the instances above but may be understood as cooking parameter variables for preparing food stuffs.

The learned modification 218 may particularly correspond to a user behavior based on inputs, functions, tasks, stoppages, extensions, changes, or other modifications the user may perform, such as during or after executing food preparation. For instance, notwithstanding the discrete selections from the user, such as corresponding to the user modification 216, the learned modification 218 may include instances of the user stopping, extending, re-starting, or otherwise altering the food preparation instruction from the selected options. In an instance such as provided above, the user modification 216 may particularly correspond to the user choice of five (5) minutes and thirty (30) seconds. However, the system 100 may observe or otherwise record that the user stops cooking at five (5) minutes and ten (10) seconds, rather than allowing cooking to run for the entire five (5) minutes and thirty (30) seconds. In another instance, the system 100 may observe or otherwise record that the user extends cooking to six (6) minutes and thirty (30) seconds, rather than allowing cooking to stop at five (5) minutes and thirty (30) seconds, or within the range provided in the food preparation instruction 214.

Referring still to FIG. 1, the appliance 102, or a remote user interface device 110, is configured to capture an image, such as an image of food to be prepared (i.e., heated, cooked, de-frosted, etc.), or “un-prepared food” and transmit the captured image to the computing system 112 as an input signal 101. The computing system 112 compares the captured image to the database 210 and determines the corresponding food preparation instruction. In certain embodiments, the computing system 112 utilizes an artificial intelligence algorithm 114 to compare the captured image to a plurality of un-prepared food images 212 at the database 210 and determine a best-fit of the food image to the un-prepared food image 212 and the corresponding food preparation instruction 214.

In certain embodiments, the artificial intelligence algorithm 114 may include a machine learning algorithm. The machine learning algorithm may generally be configured to obtain the captured image (such as depicted schematically via arrow 106), convert the captured image to a matrix or matrices of numerical values, and perform a feature extraction routine or pattern identification routine to the captured image or corresponding numerical values. The machine learning algorithm determines a best-fit analysis of the captured image, or particular features extracted from or patterns identified from the captured image, to the plurality of un-prepared food images 212 to determine the corresponding food preparation instruction 214. In various embodiments, the machine learning algorithm may include an object recognition algorithm. The object recognition algorithm may include, but is not limited to, a scale-invariant feature transform, a speeded-up robust features, a principal component analysis, or a linear discriminant analysis, or other appropriate type of object recognition algorithm.

The system 100 may furthermore output a control signal to the appliance 102 and/or the remote user interface device 110, such as depicted schematically via arrows 105. The control signal 105 includes cooking parameters corresponding to the determined food preparation instruction, or to a user-modified food preparation instruction based on the user modification 216, or the learned-model modified food preparation instruction based on the learned modification 218. The appliance 102 or the remote user interface device 110 may furthermore be configured to output a user signal corresponding to the received food preparation instruction 214, or one or more modifications 216, 218. The user signal may include a visual signal, an audio signal, an appliance configuration that may be automatically loaded to the appliance (e.g., a heat output setting, a cook duration, or changes thereto during cooking, etc.), or other signal indicating to the user the cooking parameters for the food to be prepared.

As described herein, embodiments of the system 100 provided herein may include one or more imaging devices, such as a camera, optical scanner, or other device at the appliance 102 or the remote user interface device 110. The appliance 102 or the remote user interface device 110 is configured to receive or otherwise obtain inputs corresponding to an image, or data corresponding to the image.

In particular embodiments, the plurality of appliances 102 includes a first appliance 103, such as a cooking appliance (e.g., a microwave appliance, an oven appliance, a stovetop cooking appliance, a pressure cooker appliance, an air fryer appliance, etc.) configured to receive the control signal 105. In still particular embodiments, the user signal may include an audio signal or visual signal configured inform the user of which of a plurality of second appliances 103 received the control signal 105. The user signal may particularly inform the user which device may be used for preparing the food based on the food preparation instruction 214, or more particularly based on the user modification 216 or the learned modification 218. The plurality of appliances 102 may further include a second appliance 104, such as a food storage appliance (e.g., a refrigerator appliance, a freezer appliance, etc.) configured with the imaging device to capture the un-prepared food image. Accordingly, the system 100 may include a first device (e.g., first appliance 103) configured as a cooking appliance at which the foodstuffs may be prepared based on the food preparation instruction 214, the user modification 216, or the learned modification 218. The system 100 may further include a second device (e.g., second appliance 104, remote user interface device 110) configured as an imaging device to capture images, display messages and instructions or provide communications to or from the user.

In general, system 100 may include any suitable number, type, and configuration of appliances, remote servers, network devices, and/or other external devices. System 100 may include a plurality of appliances 102 and may be able to communicate with each other or are otherwise interconnected. This interconnection, interlinking, and interoperability of multiple appliances and/or devices may commonly be referred to as “smart home” or “connected home” appliance interconnectivity.

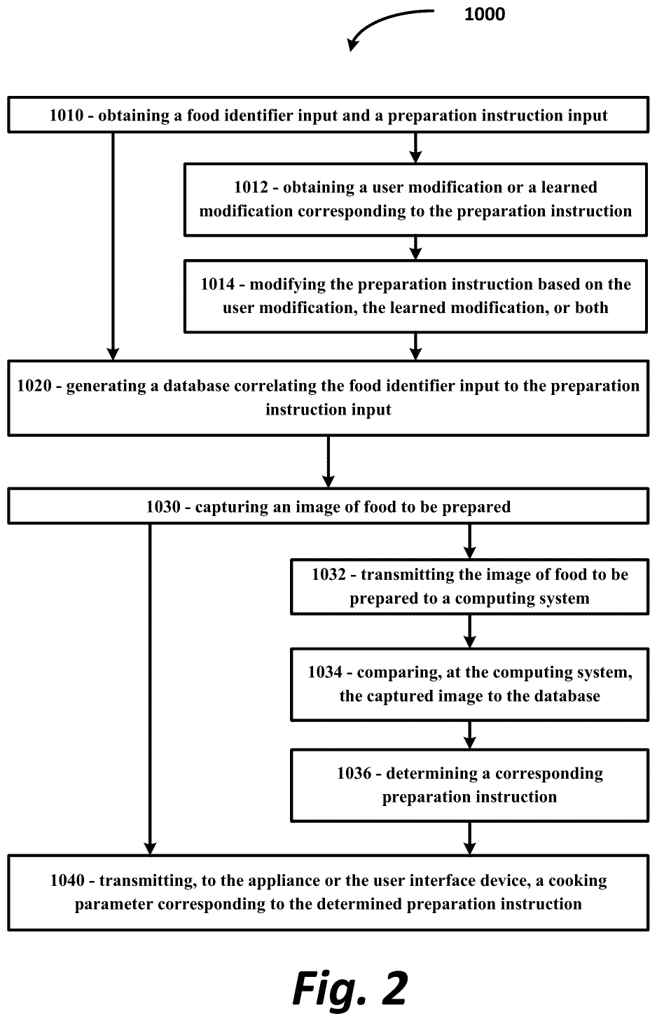

Referring now to FIG. 2, a flowchart outlining exemplary steps of a method for data transmission and appliance communication is provided (hereinafter, “method 1000”). Embodiments of method 1000 provided herein provide methods for operating a cooking appliance, methods for food preparation, or methods for determining a food preparation instruction. Steps of method 1000 provided herein may be stored as instructions and executed as operations at the system 100, or portions thereof, such as the appliance 102, the remote user interface device 110, or the computing system 112, or distributed across the plurality of portions of the system 100.

Embodiments of method 1000 include at 1010 acquiring, receiving, or otherwise obtaining a food identifier input and a preparation instruction input. The food identifier input includes a signal or data associated with an un-prepared food image, an image dataset corresponding to an un-prepared food image, an identification code, or other identifying data, such as described above in regard to food image 212. The preparation instruction input includes a cook power, a cook duration, changes in heat output, or other cooking parameters associated with the food identifier, such as described above in regard to food preparation instruction 214. In particular embodiments, method 1000 at 1010 includes acquiring, via an imaging device at an appliance or a user interface device, a food identifier and a preparation instruction input. In still particular embodiments, method 1000 at 1010 includes acquiring a plurality of food identifiers and a plurality of preparation instruction inputs.

Method 1000 includes at 1020 generating a database correlating the food identifier input to the preparation instruction input. In particular embodiments, method 1000 at includes at 1020 generating a food personality system correlating the food identifier to the preparation instruction. In still particular embodiments, method 1000 includes at 1020 generating a food personality system correlating an un-prepared food image to a food preparation instruction, such as described above.

Method 1000 includes at 1030 capturing an image of food to be prepared. In particular, capturing the image of food to be prepared includes capturing, via an imaging device at the appliance or the user interface device, an image of food to be prepared. In various embodiments, method 1000 includes at 1032 transmitting the image of food to be prepared to a computing system. Method 1000 may further include at 1034 comparing, at the computing system, the captured image to the database and at 1036 determining a corresponding preparation instruction.

In particular embodiments, the captured image of un-prepared food is separate from a captured or obtained food identifier. The food identifier may include an un-prepared food image, or corresponding image data. As described above, comparing the un-prepared food image at 1034 may include comparing the captured image to the food identifier stored at the database, such as stored at the computing system 112. Comparing the un-prepared food image to the food identifier may include performing a best-fit analysis, regression, or via utilizing an artificial intelligence algorithm or other determination such as described above configured to generate a probability of match between the un-prepared food image to the plurality of food identifiers. Determining the corresponding preparation instruction at 1036 may include determining the highest probability of match between the un-prepared food image to the plurality of food identifiers and acquiring the food preparation instruction corresponding to the best-fit food identifier.

In various embodiments, method 1000 includes at 1040 transmitting, to the appliance or the user interface device, a cooking parameter corresponding to the determined preparation instruction, such as described above. In certain embodiments, method 1000 at 1040 includes a control signal including a cooking parameter corresponding to the determined preparation instruction. The control signal may include cooking parameters that may be loaded to a cooking appliance based on the preparation instruction. The control signal may load a cook duration, a cook power, or changes in cook power or other cooking variable to the appliance, such as described above. In still certain embodiments, method 1000 at 1040 includes a user signal corresponding to food preparation instruction, such as described above.

As described herein, embodiments of method 1000 may include at 1012 acquiring or otherwise obtaining a user modification or a learned modification corresponding to the preparation instruction. Method 1000 may further include at 1014 altering, adjusting, or otherwise modifying the preparation instruction based on the user modification, the learned modification, or both, such as described above. Accordingly, the preparation instruction determined at 1036 may include a user-modified food preparation instruction based on the acquired user modification. Still accordingly, the preparation instruction determined at 1036 may include a learned-model modified food preparation instruction based on the acquired learned modification.

Details regarding the operation of the appliance 102 may be understood by one having ordinary skill in the art and detailed discussion is omitted herein for brevity. However, it should be appreciated that the specific appliance types and configurations are only exemplary and are provided to facilitate discussion regarding the use and operation of an exemplary system 100. The scope of the present subject matter is not limited to the number, type, and configurations of appliances set forth herein.

For example, system 100 may include any suitable number and type of appliances 102, such as “household appliances.” These terms are used herein to describe appliances typically used or intended for common domestic tasks, e.g., such as the appliances as illustrated in the figures. According to still other embodiments, these “appliances” may include but are not limited to a refrigerator, a dishwasher, a microwave oven, a cooktop, an oven, and any other household appliance which performs similar functions or at which an imaging device may be connected.

In addition, it should be appreciated that system 100 may include one or more external devices, e.g., devices that are separate from or external to the one or more appliances, and which may be configured for facilitating communications with various appliances or other devices. For example, the system 100 may include or be communicatively coupled with the remote user interface device 110 that may be configured to allow user interaction with some or all appliances or other devices in the system 100.

In general, remote user interface device 110 may be any suitable device separate and apart from appliance 102 that is configured to provide and/or receive communications, information, data, or commands from a user. In this regard, remote user interface device 110 may be an additional user interface to the user interface panels of the various appliances within the system 100. In this regard, for example, the user interface device 110 may be a personal phone, a smartphone, a tablet, a laptop or personal computer, a wearable device, a smart home system, or another mobile or remote device. For example, the separate device may be a smartphone operable to store and run applications, also known as “apps,” and the remote user interface device 110 be provided as a smartphone app.

As will be described in more detail below, some or all of the system 100 may include or be communicatively coupled with a computing system 112, such as configured as a remote server, that may be in operative communication with some or all appliances 102 within system 100. Thus, user interface device 110 and/or computing system 112 may refer to one or more devices that are not considered household appliances as used herein. In addition, devices such as a personal computer, router, network devices, and other similar devices whose primary functions are network communication and/or data processing are not considered household appliances as used herein.

As illustrated, appliance 102, user interface device 110, computing system 112 or any other devices or appliances in system 100 may include or be operably coupled to a controller. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

The controller may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, a controller may be operable to execute programming instructions or micro-control code associated with a cooking task or function of an appliance. In this regard, the instructions may be software or any set of instructions that when executed by the processing device, cause the processing device to perform operations, such as running one or more software applications, displaying a user interface, receiving user input, processing user input, etc., such as in accordance with one or more steps of method 1000 described herein. Moreover, it should be noted that the controller as disclosed herein is additionally, or alternatively, configured to store, execute, or otherwise operate or perform any one or more methods, method steps, or portions of methods as disclosed herein. For example, in some embodiments, methods disclosed herein may be embodied in programming instructions stored in the memory and executed by controller. The memory devices may also store data that can be retrieved, manipulated, created, or stored by the one or more processors or portions of controller. One or more database(s) can be connected to the controller through any suitable communication module, communication lines, or network(s).

The schematic diagram of the system 100 in FIG. 1 may further depict data transmission and communication system. In general, the communication system is configured for permitting interaction, data transfer, and other communications between and among the appliance 102, remote user interface device 110, and the computing system 112. For example, this communication may be used to transmit packets of data through a network and to the computing system 112 and to receive at one or more appliances 102 a control signal corresponding to a visual, audio, or other user signal or desired function, including, but not limited to, user interface selections, primary or secondary function selections, functions associated with cook duration, cook power, or other cooking function, user instructions or notifications, user preferences, or any other suitable information for improved performance of cooking at one or more appliances within system 100.

In addition, computing system 112 may be in communication with the appliance 102 and/or remote user interface device 110 through a network. In this regard, for example, computing system 112 may be a cloud-based server, and may therefore be located at a distant location, such as in a separate city, state, country, etc. According to an exemplary embodiment, remote user interface device 110 may communicate with the computing system 112 over a network, such as the Internet, to transmit/receive data packets or information, receive user inputs, transmit notifications or instructions, interact with or control the appliance 102, etc. In addition, remote user interface device 110 and computing system 112 may communicate with the appliance 102 to communicate similar information.

In general, communication between the appliance 102, remote user interface device 110, computing system 112, and/or other user devices or appliances may be carried using any type of wired or wireless connection and using any suitable type of communication network, non-limiting examples of which are provided below. For example, remote user interface device 110 may be in direct or indirect communication with the appliance 102 through any suitable wired or wireless communication connections or interfaces, such as a network. For example, network 132 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for data transmission and appliance communication, the method comprising:
obtaining a food identifier input and a preparation instruction input;
generating a database correlating the food identifier input to the preparation instruction input;
capturing an image of food to be prepared;
transmitting the image of food to be prepared to a computing system;
comparing, at the computing system, the captured image to the database; and
determining a preparation instruction corresponding to the captured image.

2. The method of claim 1, the method comprising:
transmitting, to an appliance or a user interface device, a cooking parameter corresponding to the determined preparation instruction.

3. The method of claim 1, wherein the cooking parameter comprises a cook duration, a cook power, or changes in cook power, or combinations thereof.

4. The method of claim 1, the method comprising:
obtaining a user modification or a learned modification corresponding to the preparation instruction.

5. The method of claim 4, the method comprising:
modifying the preparation instruction based on the user modification, the learned modification, or both.

6. The method of claim 5, wherein determining the preparation instruction comprises determining the user preparation instruction comprising the user modification, the learned modification, or both.

7. The method of claim 1, wherein obtaining the food identifier input comprises obtaining an un-prepared food image.

8. The method of claim 1, wherein comparing the captured image comprises comparing the captured image to the food identifier input at the database.

9. The method of claim 8, wherein comparing the captured image comprises performing a best-fit analysis of the captured image to the food identifier input at the database.

10. The method of claim 1, wherein the computing system is a cloud-based server.

11. An appliance data transmission system, the system comprising an imaging device, a cloud-computing system, and a cooking appliance, the system configured to:
obtain and transmit, via the imaging device, a food identifier input and a preparation instruction input to the computing system;
generate a database comprising the food identifier input correlated to the preparation instruction input;
capture and transmit, via the imaging device, an image of food to be prepared;
compare, at the computing system, the captured image to the database; and
determine a preparation instruction corresponding to the captured image.

12. The system of claim 11, the system configured to:
transmit, to the cooking appliance or a user interface device, a cooking parameter corresponding to the determined preparation instruction.

13. The system of claim 11, wherein the cooking parameter comprises a cook duration, a cook power, or changes in cook power, or combinations thereof.

14. The system of claim 11, the system configured to:
obtain, at the computing system, a user modification or a learned modification corresponding to the preparation instruction.

15. The system of claim 14, the system configured to:
modify the preparation instruction based on the user modification, the learned modification, or both.

16. The system of claim 15, wherein determining the preparation instruction comprises determining the user preparation instruction comprising the user modification, the learned modification, or both.

17. The system of claim 11, wherein obtaining the food identifier input comprises obtaining an un-prepared food image.

18. The system of claim 11, wherein comparing the captured image comprises comparing the captured image to the food identifier input at the database.

19. The system of claim 18, wherein comparing the captured image comprises performing a best-fit analysis of the captured image to the food identifier input at the database.

20. The system of claim 11, wherein the imaging device is at a first device. and wherein the cooking appliance is a second device.
